(19) United States
(12) Patent Application Publication
(10) Pub. No.: US 2002/0067566 A1
(43) Pub. Date: Jun. 6, 2002

(54) System and method for independent positioning of disk drive read/write heads

(76) Inventors: Michael Arkin, Dallas, TX (US); Frederick Trafton, Lewisville, TX (US); David Robbins, Longmont, CO (US)

Correspondence Address: W. Daniel Swayze, Jr., Texas Instruments Incorporated, PO Box 655474, M/S 3999, Dallas, TX, 75265, US

(21) Appl. No.: 09/731,679

(22) Filed: Dec. 6, 2000

(51) Int. Cl. G11B 5/596

(52) U.S. Cl. 360/77.02; 360/77.05; 360/77.08; 360/63

(57) ABSTRACT

A system and method are disclosed to facilitate independent positioning of a plurality of heads relative to associated disk surfaces in a disk drive system. Circuitry is provided to route position data from at least one of the heads while concurrently reading data from or writing data to another head. The position data is employed to control the position of the heads, each of which may be independently positioned by an associated positioning motor. Servo wedges associated with each surface also may be offset from each other to facilitate acquiring position data from one or more heads while data is concurrently communicated relative another head.

### TECHNICAL FIELD

The present invention relates to disk drive circuits and, more particularly, to a system and method for independent positioning of disk drive read/write heads in a hard disk drive system.

### BACKGROUND

A hard disk drive generally includes a stack of rotating disks or platters and a spindle motor that is controlled to cause the disks to rotate. Data is generally stored in the form of a sequence of magnetically polarized regions on the surface of the disk. The sequences, known as tracks, typically appear as concentric circles on the disk.

A read/write head, which is sensitive to changes in magnetic flux, reads and/or writes data to the disks as it is supported by an arm above the surface of the disks in close proximity relative to the disks. An actuator motor (typically a “voice coil motor” or VCM) controls the positioning of the arm for moving read/write heads relative to the surface of the disks. As a disk rotates under the read/write head, the read/write head “flies” on a thin cushion of air created by the motion of the disk. The read/write head reads data from a disk by sensing flux changes on the magnetic surface of an associated disk as it passes beneath the read/write head. Various types of disk drives include several disks, each surface of which has an associated read/write head.

In order to discern disk position, typically each disk includes a plurality of servo wedges on both surfaces. The servo wedges on a given surface are employed by the head to discern the position of the disk relative to the associated head, as is well known in the art. The servo wedges are typically written onto each surface one time in the life of the drive and are intended to last throughout the life of the drive. For example, axially aligned servo wedges may be written simultaneously on all the surface of a disk during a bank write process. Alternatively, servo wedges may write separately onto a disk surface so as to have an offset. The offset for each surface is known and is utilized by associated control circuitry to enable an accurate position determination based on the servo wedge data.

Typically, a preamplifier circuit is coupled to each of the heads for reading data from and/or writing data to each respective head. The preamplifier is coupled to a read channel for communicating the data to and from the selected head. By way of illustration, an input stage of the preamplifier includes multiplexing circuitry for controlling access to a different one of the read/write heads, such that data is read from or written to only one head at a given time. In general, the preamplifier circuit is operative to read or write user data respectively to and from a selected head. The writing of data may be periodically interrupted to read servo position data from a given head. The data from the preamplifier is provided to a read channel for directing the incoming data.

By way of further illustration, the read channel may include a multiplexer circuit that is operative to interrupt the flow of user data to switch over to provide the servo wedge data to an associated demodulator circuit. The demodulator processes the servo wedge position data and converts the data to a position error signal and a track ID signal for the disk surface from which the servo wedge data was read. The position information is provided to a motor control system for controlling operation of the VCM for positioning a selected head at a desired position relative to its associated disk surface.

### SUMMARY

The present invention provides a system and method to facilitate independent positioning of a plurality of heads relative to associated disk surfaces in a disk drive system. Circuitry is provided to enable independent acquisition of position data from at least one of the heads while concurrently reading data from or writing data to another head. By way of example, multiplexers may be employed to separate the user data being communicated relative to one head from position data being acquired from one or more different heads. The position data is employed to control the position of the heads, each of which may be independently positioned by an associated positioning motor. In accordance with another aspect of the present invention, servo wedges associated with each surface are offset from the wedges associated with each other surface so as to facilitate acquiring position data from one or more heads while user data is concurrently communicated relative another head. As a result, an improved throughput may be achieved from that available with a conventional disk drive system.

One aspect of the present invention provides a system to facilitate independent positioning of a plurality of heads of a disk drive. A first multiplexer is coupled to the plurality heads for multiplexing position data from the plurality of heads and providing a position signal indicative thereof. A second multiplexer is coupled to the plurality heads for multiplexing user data relative to a selected head as a data signal. A position control system provides a motor position control signal for independently controlling the position of at least some of the plurality of heads based on the position signal.

Another aspect of the present invention provides a system to facilitate independent positioning of a plurality of heads of a disk drive. The system includes a plurality of substantially coaxial disk surfaces, each disk surface having a plurality of servo wedges that are offset from servo wedges of an adjacent disk surface. A first multiplexer is coupled to the plurality heads for multiplexing position data from the plurality of heads and providing a position signal indicative thereof. A second multiplexer is coupled to the plurality heads for multiplexing user data relative to a selected head. The first and second multiplexers are operative to communicate user data relative to one of the plurality of heads concurrently with providing position data read from at least another of the heads.

Yet another aspect of the present invention provides a method to facilitate independent positioning of a plurality of heads of a disk drive. The method includes separating data communicated concurrently relative to at least two of the plurality of heads as user data and position data. A positioning motor associated with one of the at least two heads is controlled based on the position data while data is communicated relative to another of the at least two heads.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 is a schematic block representation of a system for independently positioning a plurality of heads in accordance with the present invention;

FIG. 2 is a functional block diagram of a disk drive system incorporating a positioning system in accordance with the present invention;

FIG. 3 is an example of disks configured for use in a system according to the present invention;

FIG. 4 is an example of a preamplifier circuit in accordance with the present invention;

FIG. 5 is an example of a head positioning control system in accordance with the present invention; and

FIG. 6 is a flow diagram illustrating a methodology for controlling position of a plurality of heads in accordance with the present invention.

### DESCRIPTION OF THE INVENTION

The present invention will now be described with respect to the accompanying drawings in which like numbered elements represent like features throughout the various drawings.

The present invention provides a system and method to facilitate independently controlling the position of a plurality of heads in a disk drive system. To achieve such operation, circuitry is provided to enable independent acquisition of position data from at least one of the heads while concurrently communicating user data relative to another head. The position data is employed to control the position of the heads, each of which may be independently positioned by an associated positioning motor.

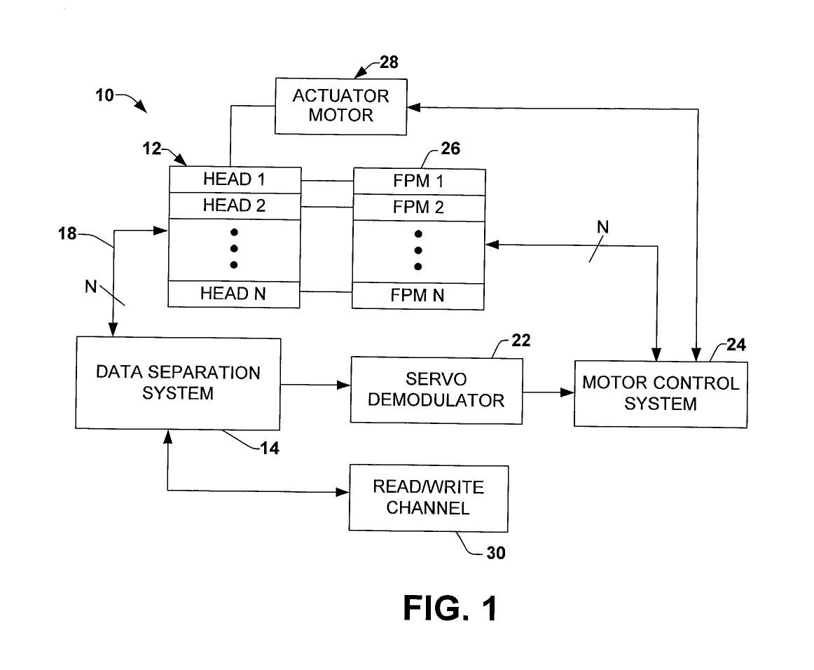

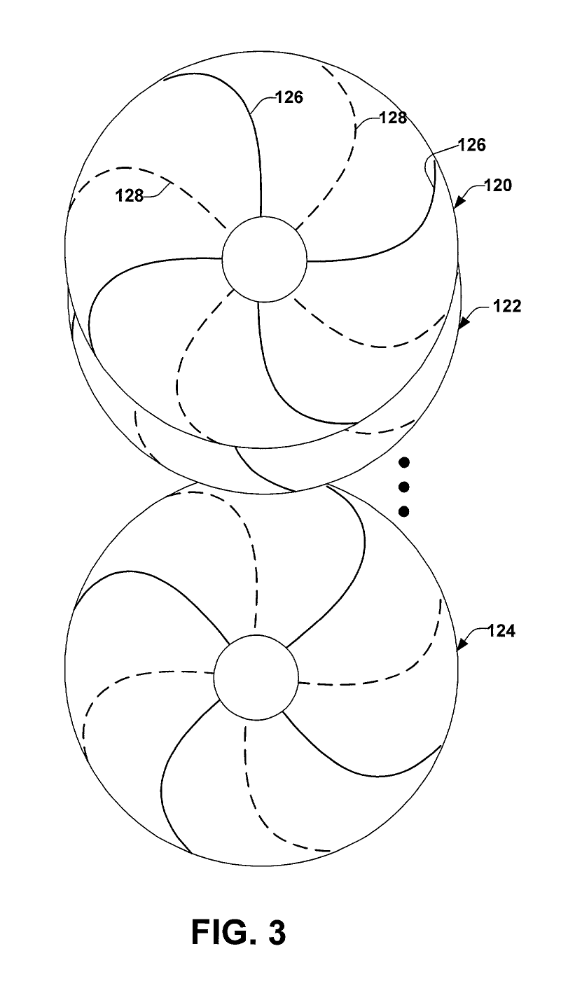

FIG. 1 illustrates a simplified block diagram of a disk drive system 10 incorporating a head positioning arrangement, in accordance with an aspect of the present invention. The system 10 includes a plurality (e.g., two or more) of read/write heads 12, which are labeled HEAD 1 through HEAD N. Each head 12 is associated with a surface of hard disk drive (not shown). Each surface includes a plurality of spaced apart servo wedges from which an associated head may extract relative position information. In accordance with an aspect of the present invention, the servo wedges of each disk surface may be angularly offset from the servo wedges of its adjacent disk surfaces. The angular offset between the servo wedges is described in further detail herein and in particular with respect to FIG. 3.

Each of the heads 12 is capable of reading and writing data to and from a disk surface. The data being read from a given head 12 may include user data and position data from the servo wedges. The disk drive system 10 includes a data separation system 14 for controlling communication of user data and position data. In accordance with an aspect of the present invention, the data separation system 14 is programmed and/or configured to communicate user data and position data relative to more than one head 12 at a given time.

While, for purposes of simplicity of illustration, a single connection 18 is illustrated as coupling the data separation system to the heads, it is to be appreciated that there typically is one or more (e.g., two) connections for each of the N heads.

In accordance with one particular aspect of the present invention, the data separation system may be implemented as part of a preamplifier circuit, which may be implemented in one integrated circuit. The data separation system 14 further may include control logic (not shown) to selectively control routing of the position data and user data. Alternatively, such control logic may be provided from a source external to the preamplifier data separation system.

The data separation system 14 outputs a servo wedge position signal, which may be an analog signal, to a servo demodulator 22. The servo demodulator 22 demodulates the position signals from the heads 12 to provide a demodulated position data signal. The demodulated position data signal, for example, may include a position error signal and a track ID signal for each of the heads. The servo demodulator 22 provides the demodulated position data signal to a motor control system 24.

The motor control system 24 is programmed and/or configured to independently control the position of one or more of the heads 12. The motor control system 24 is operatively connected to communicate control information to each of a plurality of Fine Position Motors (FPMs) 26, indicated as FPM 1 through FPM N. Each FPM 26 is operatively connected to a respective head 12 for positioning the head based on the control signal from the motor control system 24. Independent positioning of each head 12 is facilitated due to the separation of the position information and the user data by the data separation system 14. In particular, the offset between servo wedges on the disk surfaces enables position data for each of the heads to be provided to the data separation system 14 so that the position of each head may be continuously monitored. That is, relative position data may be read from one or more heads while user data is being communicated relative another head via a separate communication channel provided by the data separation system 14. As a result, position data may be obtained for each head and, in turn, utilized to selectively position each head independently. Those skilled in the art will understand and appreciate that the foregoing arrangement is a departure from the conventional approach, wherein data is read from or written to only a single head at a given time.

The system 10 further includes an actuator motor 28, such as a Voice Coil Motor (“VCM”), which may be utilized for coarse positioning of the heads 12 as a single block. The motor control system 24 thus may be further programmed and/or configured to provide a command signal for controlling the actuator motor 28. After coarse positioning of the heads 12 by the actuator motor 28, the FPMs 26 may be activated to provide for additional movement of each head 12 relative to its respective disk surface according to the available range of displacement provided by each FPM.

In addition to selectively routing position data from the heads 12, the data separation system 14 also controls routing of user data between the heads 12 and a read/write channel 30. The read/write channel 30 decodes and otherwise processes the signal from the heads 12 in a manner known in the art. By way of example, the read/write channel 30 sends the decoded data to an associated control system for processing the decoded data. The control system also may provide encoded data to the data separation system 14 for writing such data to a selected disk surface. Such control system and associated circuitry is well known in the art and has been omitted for purpose of brevity. Those skilled in the art will appreciate numerous arrangements of control systems for processing the user data, which may be utilized in connection with a positioning system in accordance with the present invention. It is to be understood and appreciated that the read/write channel 30 and the servo demodulator 22 may be part of the same integrated circuit.

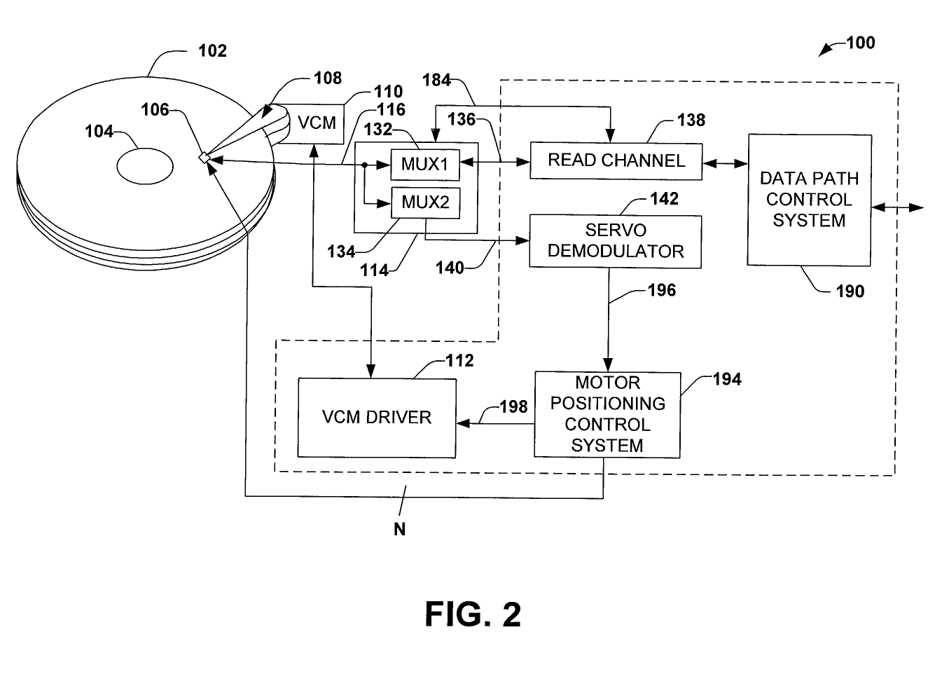

In order to provide additional context, FIG. 2 illustrates a disk drive system 100 incorporating a head positioning arrangement in accordance with an aspect of the present invention. Briefly stated, the hard disk drive system 100 includes a plurality of magnetic storage media or disks 102 mounted on a rotatable spindle, schematically indicated at 104. A spindle motor (not shown) is operatively connected to the spindle 104 so as to rotate the disks 102 when the motor is energized. Each disk 102 includes a magnetic recording surface on one or both sides of the disk, as is known in the art.

A read/write head 106 is mounted on each of a plurality of actuator arms 108, which is moved radially by an actuator motor 110, such as a VCM. A motor driver 112, such as may include a current control amplifier, controls the actuator motor 110. The driver 112, for example, controls operation of an array of power transistors (e.g., FETs), which are selectively activated and deactivated, such as based on a current (or voltage) command signal. It is to be appreciated that the actuator motor 110 typically is employed to move a plurality of support arms in unison, such as to provide a coarse level of radial movement for each read/write head 106 relative to a respective disk surface.

As is known in the art, each head 106 is operative to detect magnetic flux changes on an associated surface of the disks 102. The flux changes include both flux changes due to user data and flux changes due to position data provided by servo wedges located on the surface of the disk. Each flux change produces a signal that is readable by an associated preamplifier 114. The preamplifier 114 is coupled to each of the heads 106 through a separate connection, indicated schematically at 116.

In accordance with an aspect of the present invention, the servo wedges are formed on each surface in a manner to facilitate independently reading position data from at least a plurality of the heads. By way of illustration, FIG. 3 depicts an example of N media disks (where N is a positive integer) 120, 122, and 124. For example, a high performance disk drive may have from four to ten such disks. Each disk 120, 122, 124 has two surfaces. Each surface has a plurality of servo wedges arcuately extending from an inner diameter to an outer diameter of the respective disk. Servo wedges 126 on a first surface of each disk are illustrated as solid lines and servo wedges 128 on the opposed surface of each disk are illustrate in phantom.

In this example, the servo wedges 126, 128 on each disk surface are offset by a known amount of angular rotation relative to the axial position of the servo wedges on at least some of the other surfaces. By way of illustration, the servo wedges on the first surface of the disk 120 may correspond to an angular position of zero. The servo wedges on each other surface moving axially from the surface designated as position zero may be consecutively offset by a known amount of angular rotation. That is, a desired offset may be implemented by applying the servo wedges onto each disk surface rotated a predetermined number of angular degrees for each disk surface. The angular spacing between the servo wedges on each given surface, however, should be known and may remain fixed.

In this way, at least some of the servo wedges of a given disk surface are not coincident with the wedges of another disk surface. In certain applications, it may be desirable to select an offset so that all the servo wedges of each surface are non-coincident with each other. As a result of providing disk surfaces having offset servo wedges in the system 100, the heads associated with each surface are able to detect associated servo wedge data at non-overlapping timing intervals. The offset, in turn, is utilized to synchronize routing of data through the preamplifier for reading servo wedge data continuously for all the heads.

While the particular wedges illustrated in FIG. 3 are continuous from the inner diameter to the outer diameter of each disk, it will be understood and appreciated that non-continuous, multi-zone wedges also could be utilized in accordance with an aspect of the present invention.

Referring back to FIG. 2, the preamplifier 114 includes a pair of multiplexers 132 and 134 that are coupled to each of the heads through corresponding connections indicated at 116. The first multiplexer (MUX 1) is operative to selectively communicate user data 136 between a selected one of the heads 106 and a read/write channel 138. The flow of user data may be bidirectional. The second multiplexer (MUX 2) 134 is operative to read position data from the heads 106 and provide a position data signal 140 to a servo demodulator 142, such as corresponding to servo wedge position data from each of the plurality of heads 106. The preamplifier 114 further may include circuitry to control routing of the user data and the servo wedge data signals to and from the heads 106. The routing of the user data and servo wedge data may, in accordance with an aspect of the present invention, be concurrent such that at least some of the data is being written to or read from more than one head at a given time.

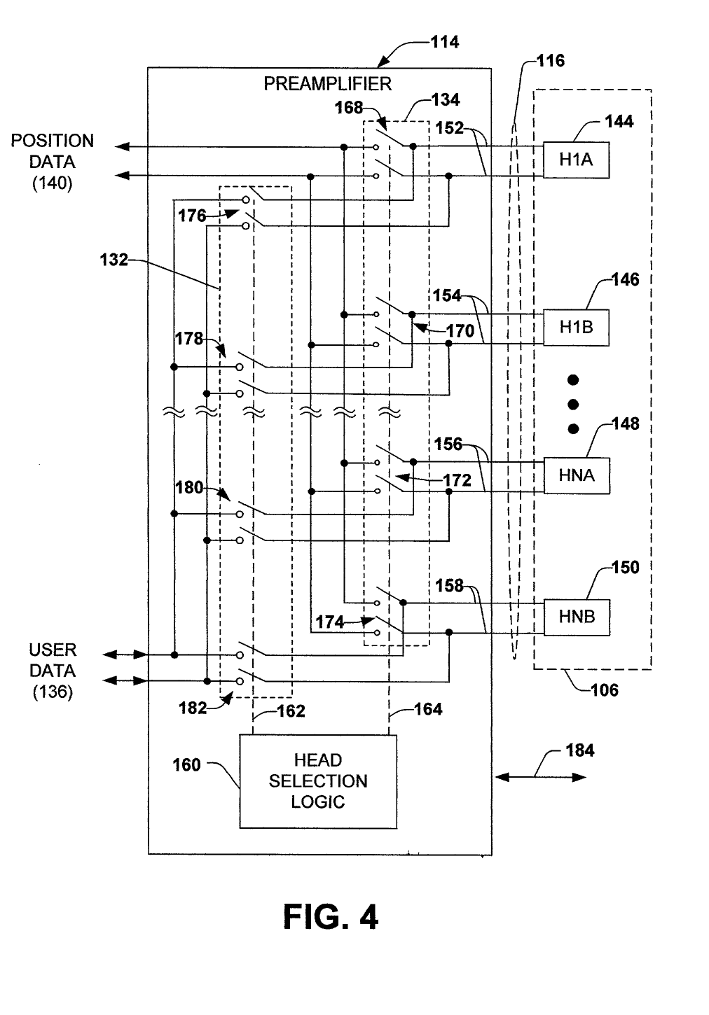

FIG. 4 illustrates an example of the preamplifier 114 in accordance with an aspect of the present invention. As mentioned above, the preamplifier is coupled to each of a plurality of heads, indicated schematically at 144, 146, 148, and 150, through respective connections 152, 154, 156, and 158 (collectively indicated at 116). By of illustration, heads 144 and 146 are associated with surfaces A and B of disk 1 and heads 148 and 150 are associated with surfaces A and B of disk N. The preamplifier 114 includes the multiplexer circuits 132 and 134 and head selection logic 160. The head selection logic provides control signals 162 and 160 to control the respective multiplexers 132 and 134 for selectively routing data through the multiplexers.

By way of example, the multiplexer circuits 132 and 134 are depicted as an array of switches. The multiplexer 134 includes a pair of switches 168, 170, 172 and 174 associated with each respective head 144, 146, 148 and 150. Similarly, the multiplexer 132 includes a pair of switches 176, 178, 180 and 182 associated with each respective head 144, 146, 148 and 150. The head selection logic 160 selectively activates and deactivates switches in each multiplexer, such that the data from a desired head is provided to the appropriate outputs 140 and 136.

Those skilled in the art will understand and appreciate various techniques that may be implemented to provide desired functionality of the multiplexer circuits, all of which are considered as being within the scope of the present invention. It is to be further appreciated that the multiplexer circuits 132 and 134 could be implemented with one or more integrated circuits, which may or may not form part of the preamplifier circuit.

The preamplifier 114 may include a connection (e.g., a serial input port) 184 for receiving data indicating which head to connect to the read/write channel 138 and which head to connect to the servo demodulator 142 (FIG. 2). The head selection logic 160 may access the data provided via the connection 184, as needed, to control activation of the switches 168, 170, 172 and 174 to synchronize reading servo wedge data from the heads as well as to control the switches 176, 178, 180, and 182 for communicating user data relative to a selected head. The connection 184 also may be connected to the read channel 138 (FIG. 2) for purposes of noise immunity. The control signals provided to the preamplifier 114 and read channel 138 via the connection 184 may be derived at a separate integrated circuit (not shown).

In view of the foregoing, it is to be appreciated that the multiplexer circuits 132 and 134 of the preamplifier circuit 114 provide separate data paths for the position data and the user data, respectively. As a result, user data may be communicated to and from a head while concurrently reading position data from another head.

Referring back to FIG. 2, the position data corresponds to servo wedge data, which is provided to the servo demodulator 142 via the output connection 140, and the user data is communicated with the read channel 138 via the output connection 136. The read channel 138 sends decoded data to an associated data path control system 190. The data path control system 190 includes circuitry for controlling reading and writing of user data respectively from and to the disks 102. Because such circuitry is well known in the art, a detailed description thereof has been omitted for sake of brevity. Briefly stated, the data path control system 190 may include a phase-locked loop that communicates with the read channel to ensure that the data is read from the disks 102 with proper synchronization. The control system 190 further may include an application-specific integrated circuit (ASIC) or other processing circuitry for processing the decoded user data. The ASIC, for example, communicates with the read channel 138, with memory (e.g., a dynamic RAM unit, a static RAM unit, a flash memory unit, etc.), which may be coupled to an external data bus.

The servo demodulator 142 is coupled to a motor positioning controller 194 for providing a signal 196 indicative of the demodulated position data detected by the heads 106. The demodulated position data may include a position error signal and a track ID signal for each of the disk surfaces. Because, in accordance with an aspect of the present invention, the servo wedges on the different disks 102 are offset from each other, the servo wedge data may represent the relative position for the disk surfaces independently (see, e.g., FIG. 3), even while user data is being written to or read from another disk surface.

Accordingly, position data for each head 106 may be extracted from the demodulated signal. By way of example a demultiplexer may demultiplex the demodulated signal into component position signals corresponding to each head. The component position signals may be further processed to provide motor position signals to individually control a FPM associated with each head 106. As a result, each head 106 may be positioned independently within the range of displacement provided by the respective FPM.

The motor positioning controller 194 further may provide a positioning command signal 198 to the actuator driver 112 for controlling operation of the actuator motor (e.g., VCM) 110. As mentioned above, the actuator motor 110 is employed for coarse positioning of the actuator arm block 108 to which the heads 106 are attached. The actuator driver 112 provides a voltage or current command signal to a switching circuit (e.g., an array of FETs) to provide a desired amount of electrical energy to the actuator motor 110. One or more conditions (e.g., voltage, current, etc.) of the actuator motor 26 may be sensed to facilitate motor control, as is known in the art.

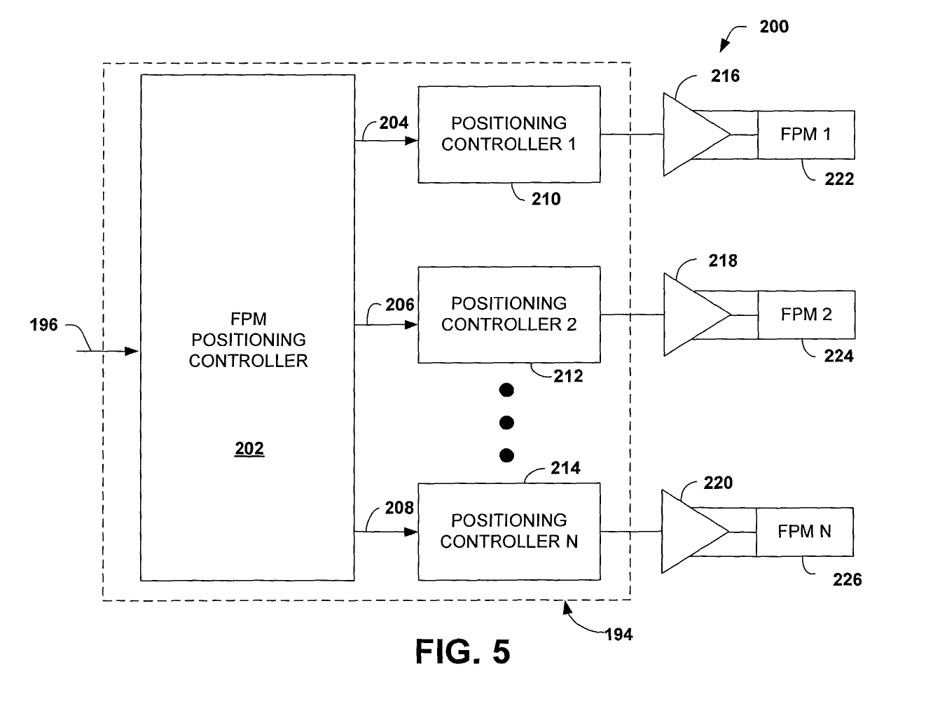

FIG. 5 illustrates an example of a control arrangement 200 that may be employed to provide per-motor positioning control in accordance with an aspect of the present invention. The control arrangement 200 includes the motor positioning controller 194 that receives the demodulated position data signal 196. The position data signal 196 is provided to a positioning controller 202. The positioning controller 202 extracts the position error and track ID signals for each respective head, such as by appropriately demultiplexing the demodulated signal 196. The positioning controller provides output signals 204, 206 and 208 to respective individual positioning controllers 210, 212, and 214 associated with each head. In particular, each positioning controller 210, 212, and 214 is coupled to an associated driver 216, 218, and 220, respectively, for providing command signals for controlling operation of an associated FPM 222, 224, and 226, respectively.

In accordance with an aspect of the present invention, the independent control of each FPM 222, 224, 226 enables each head 106 (FIG. 2) to be positioned independently of each other. The independent displacement of each head across its associated disk surface further enables heads to be pre-positioned in anticipation of where a next segment of data is to be read from or written to an associated disk surface. Accordingly, the foregoing arrangement may be utilized to implement a zero latency seek. For example, when an end of a data segment is reached, a next data segment can be made immediately available by switching the data signals to the next appropriate head in the file chain. As a result, data may be made available to a user more rapidly, thereby increasing throughput in the hard disk drive system.

Those skilled in the art will understand and appreciate numerous algorithms or control techniques that may be implemented, in accordance with the present invention, to independently position one or more heads in a disk drive system.

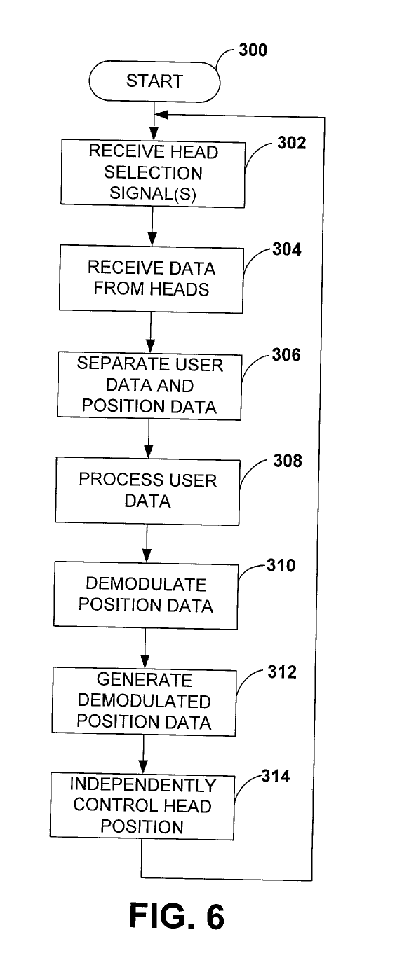

FIG. 6 is a flow diagram representing a methodology for independently positioning heads of a disk drive system in accordance with an aspect of the present invention. While, for purposes of simplicity of explanation, the methodology of FIG. 6 is shown and described as a series of steps, it is to be understood and appreciated that the present invention is not limited to the order of steps, as some steps may, in accordance with the present invention, occur in different orders and/or concurrently with other steps from that shown and described herein. For example, a methodology in accordance with an aspect of the present invention may be represented as a combination of various states (e.g., in a state diagram). Moreover, not all illustrated steps may be required to implement a methodology in accordance with an aspect the present invention.

Turning now to FIG. 6, the methodology begins at step 300, such as in connection with initiating reading data from or writing data to a hard disk drive having a plurality of disk surfaces. A read/write head is associated with each surface for respectively reading from or writing to the storage media. In accordance with an aspect of the present invention, at least some of the heads each have their own positioning motor for independently positioning each respective head across its associated disk surface. An actuator motor (e.g., a VCM) also may be operatively connected with the heads for coarse positioning of such heads as a block. From step 300, the process proceeds to step 302.

At step 302, head selection signals are provided, such as to a pair of analog multiplexer circuits. The head selection signals, for example, are generated in response to timing signals received from associated control circuitry that determines which heads are to be accessed for reading and/or writing data. Next, at step 304 data is read from a plurality of the heads. The data may include user data and/or position data. The user data is bi-directional in that the data may be written to or read from a disk surface by a given head. From step 304, the process proceeds to step 306.

At step 306, user data (e.g., bidirectional) is separated from position data based on the head selection signals. By way of example, a pair of multiplexers coupled to the heads may be employed to selectively route servo wedge data to a servo demodulator and to selectively route user data to and/or from a read channel of the disk drive system. Advantageously, such an arrangement enables position data to be read from the heads concurrently with user data being written to or read from a given head. The reading of position information from the plurality of heads is facilitated due to the rotational offset of servo wedges on each disk surface, such as shown and described herein.

Next, at step 308, the user data is processed in a known manner. The processing of user data, for example, includes analog-to-digital conversion and storing of data to appropriate memory. The data being read is determined by the head that has been coupled to the read channel based on the head selection signal (step 302).

The position data is provided to a servo demodulator, which demodulates the position data at step 310. Next, at step 312, a demodulated position data is generated. The demodulated servo data may include position error signals and track ID signals as read by each of the heads. This may be implemented by the head selection signals selectively connecting each head to the servo demodulator in synchronization with alignment between each respective head and the offset servo wedges on its associated disk surface. Because, in accordance with an aspect of the present invention, the servo wedges in some or all of the disk surfaces do not axially coincide with each other, there is no overlap in reading the servo wedge data for the disk surfaces. As a result, the disk drive system is able to obtain position information for all or some of the heads by synchronizing routing of data from each head accordingly.

From step 312, the process proceeds to step 314 in which the position of one or more heads are independently controlled, such as by selectively controlling operation of a FPM associated with each such head. The error position signals and track ID signals, for example, may be employed to accurately position each head to a desired position relative to its associated disk surface. From step 314 the process returns to step 302 and may continue in this manner until the reading and/or writing process ends.

The independent positioning of the heads across their associated disk surfaces further enables heads to be pre-positioned in anticipation of where a next segment of data is to be read from or written to an associated disk surface. Those skilled in the art will understand and appreciate anticipatory algorithms that may be utilized to predict where a next data segment is to be read from or written to. For example, when an end of a data segment is reached, a next data segment can be made immediately available by switching the data signals to the next appropriate head in the file chain, which, in accordance with an aspect of the present invention may be positioned in advance of a corresponding read or write cycle. As a result, data may be made available to a user more rapidly, thereby increasing throughput in the hard disk drive system. In addition, a methodology in accordance with the present invention mitigates the occurrence of short seeks conducted in the transfer of data, such as is typically associated with long file transfers.

Although the invention has been shown and described with respect to a certain embodiments, it will be appreciated that equivalent alterations and modifications will occur to others skilled in the art upon the reading and understanding of this specification and the annexed drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure, which performs the function in the herein illustrated exemplary embodiments of the invention. In this regard, it will also be recognized that the invention includes a computer-readable medium having computer-executable instructions for performing the steps of the various methods of the invention. In addition, while a particular feature of the invention may have been disclosed with respect to only one of several embodiments, such feature may be combined with one or more other features of the other embodiments as may be desired and advantageous for any given or particular application. Furthermore, to the extent that the terms “includes”, “including”, “has”, “having”, and variants thereof are used in either the detailed description or the claims, these terms are intended to be inclusive in a manner similar to the term “comprising.”

What is claimed is:

1. A system to facilitate independent positioning of a plurality of heads of a disk drive, comprising:
a first multiplexer coupled to the plurality heads for multiplexing position data from the plurality of heads and providing a position signal indicative thereof;
a second multiplexer coupled to the plurality heads for multiplexing user data relative to a selected head as a data signal; and
a position control system that provides a motor position control signal for independently controlling the position of at least some of the plurality of heads based on the position signal.

2. The system of claim 1, further comprising a preamplifier coupled to the plurality heads, the preamplifier including the first and second multiplexers.

3. The system of claim 1, further including a demodulator connected between the first multiplexer and the position control system for receiving the position signal and providing a demodulated position signal to the position control system.

4. The system of claim 3, wherein the demodulated position signal includes at least one of an error position signal and a track identification signal for the plurality of heads, the position control system employing the at least one of an error position signal and a track identification signal to independently position the at least some of the plurality of heads.

5. The system of claim 1, further including at least two substantially coaxial disk surfaces, each surface having a plurality of servo wedges that are offset from servo wedges of an adjacent disk surface.

6. The system of claim 5, further including head selection logic for controlling the first and second multiplexers, such that the position signal from the first multiplexer includes servo wedge data detected by heads associated with the at least two disk surfaces.

7. The system of claim 6, wherein the head selection logic is operative to control the first and second multiplexers, such that user data is communicated relative to one of the plurality of heads concurrently with position data being read from at least another of the plurality of heads.

8. The system of claim 1, further including a separate positioning motor associated with at least some of the plurality of heads, the position control system providing a control signal to each of the positioning motors for independently positioning respective heads.

9. The system of claim 1, further including head selection logic for controlling the first and second multiplexers such that user data is communicated relative to one of the plurality of heads concurrently with position data being read from at least another of the plurality of heads.

10. A system to facilitate independent positioning of a plurality of heads of a disk drive, comprising:
a plurality of substantially coaxial disk surfaces, each disk surface having a plurality of servo wedges that are offset from servo wedges of at least another disk surface; and
a data separation system operative to route position data from the plurality of heads and provide a corresponding position signal indicative thereof, the data separation system being further operative to route user data relative to another of the plurality of heads and provide a corresponding user data signal indicative thereof concurrently with providing the position signal.

11. The system of claim 10 wherein the data separation system further comprises a first multiplexer coupled to the plurality heads for multiplexing the position data from the plurality of heads as the position signal and a second multiplexer coupled to the plurality heads for multiplexing the user data relative to a selected head as the user data signal.

12. The system of claim 11, further including head selection logic for controlling the first and second multiplexers to communicate user data relative to one of the plurality of heads concurrently with providing position data read from at least another of the plurality of heads, the position data including servo wedge data detected by heads associated with the plurality of disk surfaces.

13. The system of claim 11, wherein the servo wedges of each disk surface are offset from servo wedges of each other disk surface so as to be axially noncoincident with the servo wedges of the other disk surfaces.

14. The system of claim 13, wherein the servo wedges extend generally radially along a disk surface between an inner diameter and an outer diameter.

15. The system of claim 11, further comprising a position control system operative to provide a motor position control signal for independently controlling the position of at least some of the plurality of heads based on the position signal.

16. The system of claim 15, further comprising a separate positioning motor associated with at least some of the plurality of heads, the position control system providing independent control signals to each of the positioning motors for independently positioning respective heads based on the position signal.

17. The system of claim 15, further including a demodulator connected between the first multiplexer and the position control system for receiving the position signal and providing a demodulated position signal to the position control circuit.

18. The system of claim 17, wherein the demodulated position signal includes at least one of an error position signal and a track identification signal for the plurality of heads, the position control system independently positioning the respective heads based on the at least one of an error position signal and a track identification signal for the respective heads.

19. The system of claim 11, further including head selection logic for controlling the first and second multiplexers such that user data is communicated relative to one of the plurality of heads concurrently with position data being read from at least another of the plurality of heads.

20. A system to facilitate independent positioning of a plurality of heads of a disk drive, comprising:
means for concurrently routing data from at least two of the plurality of heads into a user data signal and a position data signal; and
means for independently positioning at least some of the plurality of heads based on the position data signal.

21. The system of claim 20, wherein the means for routing data further comprises first multiplexing means for multiplexing position data read from a selected one of the plurality of heads as the position data signal and second multiplexing means for multiplexing user data relative to another selected head as the user data signal.

22. A method to facilitate independent positioning of a plurality of heads of a disk drive, wherein each of the plurality of heads is operatively coupled to a separate positioning motor, the method comprising:
separating data being communicated concurrently relative at least two of the plurality of heads into a user data signal and a position data signal; and
controlling a positioning motor associated with one of the at least two heads based on the position data while data is communicated relative to another of the at least two of the plurality of heads.

23. The method of claim 22, wherein the step of separating further comprises multiplexing position data read from a selected one of the plurality of heads and multiplexing user data relative to another selected head.

24. The method of claim 22, further including controlling an actuator motor coupled to the plurality of heads for coarse positioning the plurality of heads as a block.
